(19) United States
(12) Patent Application Publication
(10) Pub. No.: US 2011/0047893 A1
(43) Pub. Date: Mar. 3, 2011

(54) Data Enhanced Tombstone or Grave Marker

(76) Inventor: Enio Iezza, Whittier, CA (US)

(21) Appl. No.: 12/869,112

(22) Filed: Aug. 26, 2010

Related U.S. Application Data
(60) Provisional application No. 61/237,203, filed on Aug. 26, 2009.

(51) Int. Cl. E04H 13/00; A61G 99/00

(52) U.S. Cl. 52/103; 52/173.1; 27/1

(57) ABSTRACT

A data enhanced tombstone contains audio, video, or text of the deceased and means to communicate to an electronic user device reproducing the audio and visual images.

The present application claims the priority of U.S. Provisional Patent Application Ser. No. 61/237,203 filed Aug. 26, 2010, which application is incorporated in its entirety herein by reference.

### BACKGROUND OF THE INVENTION

The present invention relates to a data enhanced tombstone, grave marker, columbaria, and the like containing information about the deceased and in particular to a tombstone providing an audio, video, text, and/or still photos and having a unique ID number.

Throughout history and across cultural divisions, a variety of different ceremonies and memorials have been used to commemorate the death of a loved one. Indeed, ceremonies and memorials have become integral for helping the living cope with the death and for commemorating the loved one for future generations. For instance, traditional western ceremonies typically involve a funeral home visitation, a burial, and a wake, with the grave site being marked by a headstone. In the case of cremation, ashes are often placed in a sealed urn. For many historically significant individuals, their deaths are sometimes commemorated with a memorial, such as a statue, which is often dedicated years after that individual's death.

While traditional ceremonies and memorials are without a doubt important, there are shortcomings. For instance, visitors have traditionally been required to be physically present at the ceremony or the memorial to view or reflect on the individual. If not physically present at the ceremony or the memorial, one cannot share in the achievements and memories associated with the individual. To address this shortcoming, a simple, sole data storage device stored in a tombstone, grave marker, or the like will benefit future generations by allowing them to experience videos of a deceased.

Currently, there are methods for viewing information about a deceased at specific gravesites. The information is viewed by specific programs or applications that are packaged together. These complete packages make up the process for viewing the information. Current technology has improved, whereas only data needs to be stored in the tombstone, whereby common user-hand-held electronic and the electronic multiple hardware tools can retrieve this data. There is no need to package components, such as video display panels or computer hardware and software. Thus, there is only a need to store data in the tombstone.

U.S. Pat. No. 5,517,791 issued May 21, 1996 to Weiss teaches a monument with movable element. This prior art does not teach a data enhanced tombstone.

U.S. Pat. No. 5,622,014 issued Apr. 22, 1997 to Weiss teaches a columbarium structure comprising several niche units each of which has a door hingably attached to it, within which door, a rotatable element is mounted. This prior art does not teach a data enhanced tombstone.

U.S. Pat. Nos. 6,006,458 and 6,088,973 issued Dec. 28, 1999 and Jul. 18, 2000, respectively, both to Weiss, teach monument markers and columbaria with improved display indicia. This prior art does not teach a data enhanced tombstone.

U.S. Pat. No. 6,340,978 issued Jan. 22, 2002 to Mindrum teaches a method and apparatus for recording and presenting life stories. This system comprises a computer with database containing a great deal of information about the deceased on a memory tube, rather than provide a communication from the deceased which has been videotaped prior to passing away. In addition, the memory tube is stored in the coffin; therefore, this prior art does not teach a data enhanced tombstone.

U.S. Pat. No. 7,089,495 issued Aug. 8, 2006 to Barrows teaches a video tombstone comprising all the components to make the video display function, such as: CPU, power supply, hard drive, memory cards, etc., essentially an entire computer system. This prior art does not teach a data enhanced tombstone.

### BRIEF SUMMARY OF THE INVENTION

The present invention addresses the above and other needs by providing a data enhanced tombstone containing audio, video, or text of the deceased and means to communicate to an electronic user hand held device accessing the audio and visual images, thereby providing an improved method and apparatus for the reflection upon the life of the deceased.

In accordance with one aspect of the invention, there is provided a grave marker or tombstone which incorporates an electronic multimedia data storage device attached to a grave marker or tombstone. The electronic multimedia storage device has standard features such as but not limited to; read only, read and writable, switch enabled read only, and the ability to store multiple formats such as but not limited to; text files, video files, images, audio files, executable programs. The user hand held device will be used to view the visual and audio information. An interface will be used to communicate between the data enhanced tombstone and user hand-held device.

In accordance with another aspect of the invention, there is provided a user device such as and not limited to a laptop or cell phone which is connected via cable or wireless interface to the data enhanced tombstone. There are several user devices manufactured by IBM, Apple, Sony, and the like. Thus, the person visiting the gravesite will connect to the data enhanced tombstone to view and hear the sounds and images of the deceased.

In accordance with yet another aspect of the invention, there is provided content stored on a server accessible by the Internet and can be retrieved by authorized individuals should the component in the tombstone malfunction. A new component with retrieved data from the server can be installed. Some content may be private and secured from public access. Security will apply to both the Internet Server and the data enhanced tombstone.

In accordance with yet another aspect of the invention, there is provided a data enhanced tombstone not requiring a complete computer system attached to the tombstone to view information about the deceased. Only simple and inexpensive components requires replacement in the case of a malfunction of the data storage device. Tremendous cost benefits are provided for the initial purchase and replacement of the data storage device. The data storage device is small and can be installed with horizontal, vertical, or diagonal orientation. The location of the storage device will be easily accessible if service is required. As a result, the data enhanced tombstone according to the present invention overcomes the deficiencies and problems associated with the prior art such as costly replacement of video screens, CPU's, speakers, solar panels, and the like. Only a lone data storage device will be replaced.

In accordance with another aspect of the invention, there is provided a tombstone, grave marker, etc. hosting messages retrieved by user hand-held devices, such as laptops, iPOD, iPAD, and cell phones and their associated interface connection.

In accordance with yet another aspect of the invention, there is provided a tombstone, grave marker, etc. having a unique ID readable by a hand held device. The unique ID is used to link to data stored in the hand held device or to data retrieved from the Internet, providing audio, video, text, and/or still photos associated with the unique ID number.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a representative isometric front view of a preferred embodiment of an improved apparatus for the data enhanced tombstone of the present invention.

FIG. 1B is a representative isometric front view of a preferred embodiment of an improved apparatus for the data enhanced grave marker of the present invention.

FIG. 2A is another representative isometric front view of a preferred embodiment of the improved apparatus for the data enhanced tombstone with a side mounting electronic multimedia data storage device as a retrofit to an existing tombstone.

FIG. 2B is another representative isometric front view of a preferred embodiment of the improved apparatus for the data enhanced grave marker with a side mounting electronic multimedia data storage device as a retrofit to an existing grave marker.

FIG. 3A is a representative perspective side view of a preferred embodiment of the improved apparatus for the data enhanced tombstone such as shown in FIG. 1A.

FIG. 3B is a representative perspective side view of a preferred embodiment of the improved apparatus for the data enhanced grave marker such as shown in FIG. 1B.

FIG. 4A is a front view of the improved apparatus for the data enhanced tombstone such as shown in FIG. 1A.

FIG. 4B is a cross-section cut side view of the improved apparatus for a data enhanced tombstone such as shown in FIG. 4A.

FIG. 5A is a representative perspective view of a preferred embodiment of a method of use of the improved apparatus for the data enhanced tombstone such as shown in FIG. 1A, including a hard wired interface.

FIG. 5B is a representative perspective view of a preferred embodiment of a method of use of the improved apparatus for the data enhanced grave marker such as shown in FIG. 1B, including a wireless interface.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical. The Data Enhanced Tombstone comprises a tombstone, grave marker, monument, or any tangible structure indentifying the location of a deceased, such that an electronic multimedia storage device is attached or embedded to the grave marker. The electronic multimedia storage device has standard features such as but not limited to; read only, read and writable, switch enabled read only, and the ability to store multiple formats such as but not limited to; text files, video files, images, audio files, executable programs, and a unique ID number. These files can be public or private using standard security encryption, passwords.

Additional features referring to connectivity to a user hand-held device can be a cable such as USB or serial cable or any cable that allows communication between the data storage device and the user. Connectivity can also occur via wireless connection such as but not limited to; WiFi, Bluetooth, RF and the like. Additionally, the data storage device is removable with a special key. A special cap is used to protect the electronic multimedia data storage device. Features of the cap include but not limited to; waterproofing, locking, hinged or unhinged, tethered or untethered. Also the cap is designed with a low profile or flush mounting to prevent a tripping hazard. A power source for a transmitter, if present, is preferably selected from a solar power cell, a battery, or a magnetic power unit (for example, and inductive power source). The user hand-held device can be common such as cell phones, iPods, hand-held computers and the like, allowing connectivity with the electronic multimedia data storage device.

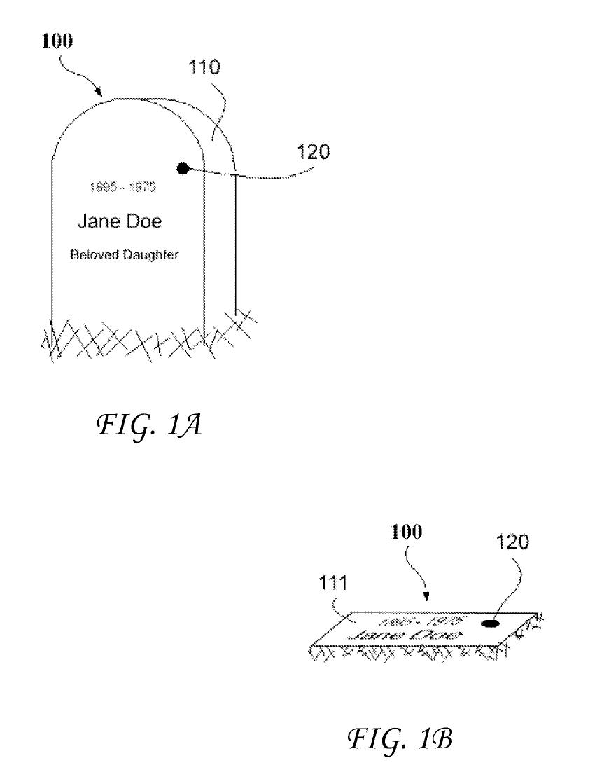

FIG. 1A is a representative isometric front view of a preferred embodiment of an improved apparatus for the data enhanced tombstone 100 of the present invention. The housing portion 110 may be constructed using typical or traditional tombstone materials, or using composites, carved materials, injection or other types of molded forms, etc. The electronic multimedia data storage device 120 is mounted into the front surface of the housing portion 110.

FIG. 1B is a representative isometric front view of a preferred embodiment of an improved apparatus for the data enhanced grave marker 100 of the present invention. The housing portion 111 may be constructed using typical or traditional grave marker materials, or using composites, carved materials, injection or other types of molded forms, etc. The electronic multimedia data storage device 120 is mounted into the top surface of the housing portion 111.

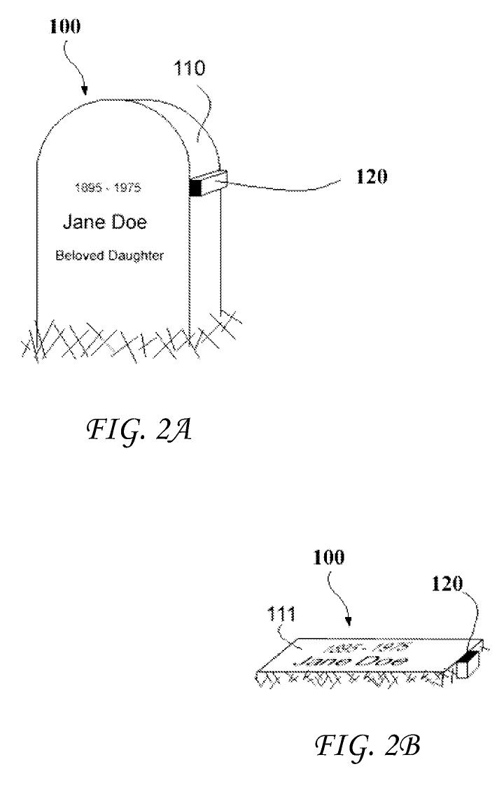

FIG. 2A is a representative isometric front view of a preferred embodiment of an improved apparatus for the data enhanced tombstone 100 of the present invention with a side mount electronic multimedia data storage device 120 attached to the housing portion 110 as a retrofit option.

FIG. 2B is a representative isometric front view of a preferred embodiment of an improved apparatus for the data enhanced grave marker 100 of the present invention with a side mount electronic multimedia data storage device 120 to the housing portion 111 as a retrofit option.

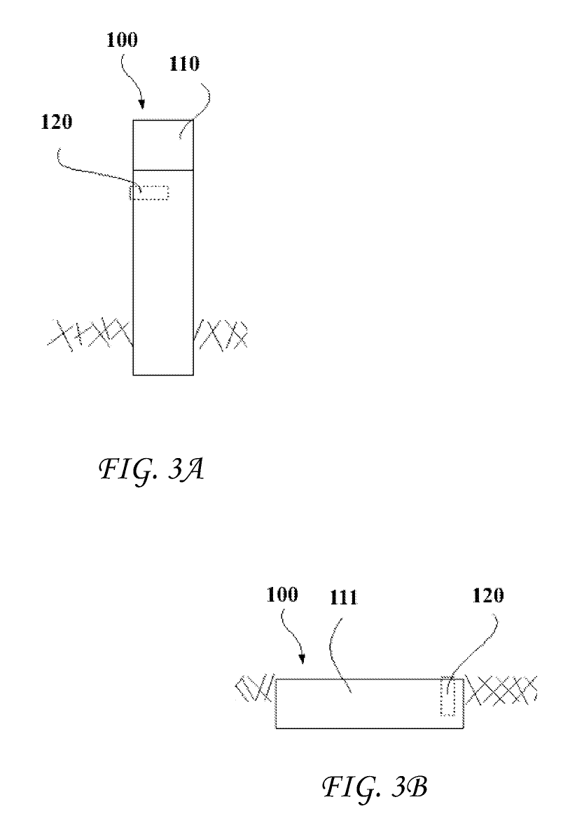

FIG. 3A is a representative perspective side view of a preferred embodiment of an improved apparatus for the data enhanced tombstone 100 such as shown in FIG. 1A.

FIG. 3B is a representative perspective side view of a preferred embodiment of an improved apparatus for the data enhanced grave marker 100 such as shown in FIG. 1B.

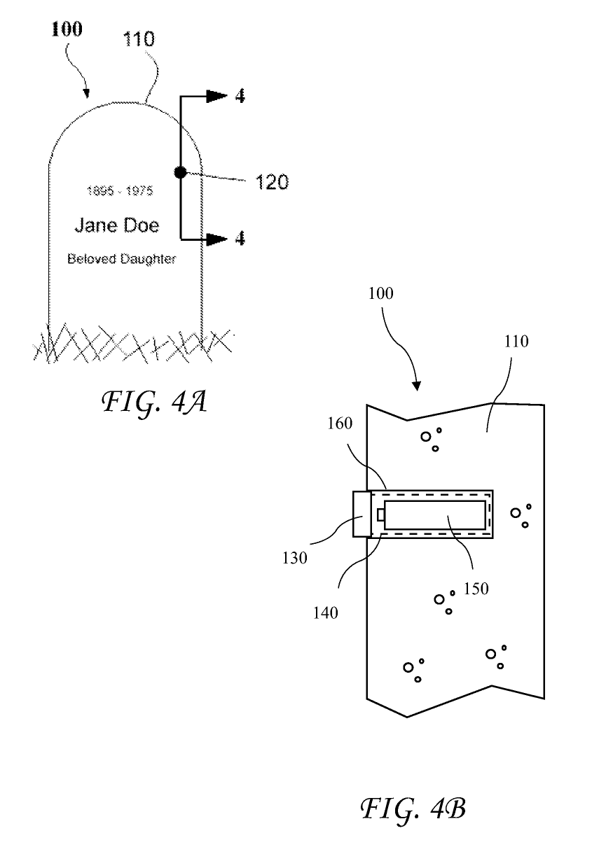

FIG. 4A is a front view of a preferred embodiment of the improved apparatus for the data enhanced tombstone 100 such as shown in FIG. 1A with a cross-section line 4-4 used to identify the location of the cross-sectional cut.

FIG. 4B is a cross-sectional view along line 4-4 of FIG. 4A of a preferred embodiment of the improved apparatus for the electronic multimedia data storage device 120. As shown, a container 160 resides in the housing 110. Opening the access cap 130 with a key can reveal the content of container 160.

The attaching method 140 represented by dotted lines allows the removal or installation of the data storage device 150 to the container 160. The attaching method 140 represented by the dotted lines can be any method such as C-clip or threads or any other means. The data storage unit 150 can be removed from the container 160 with a key.

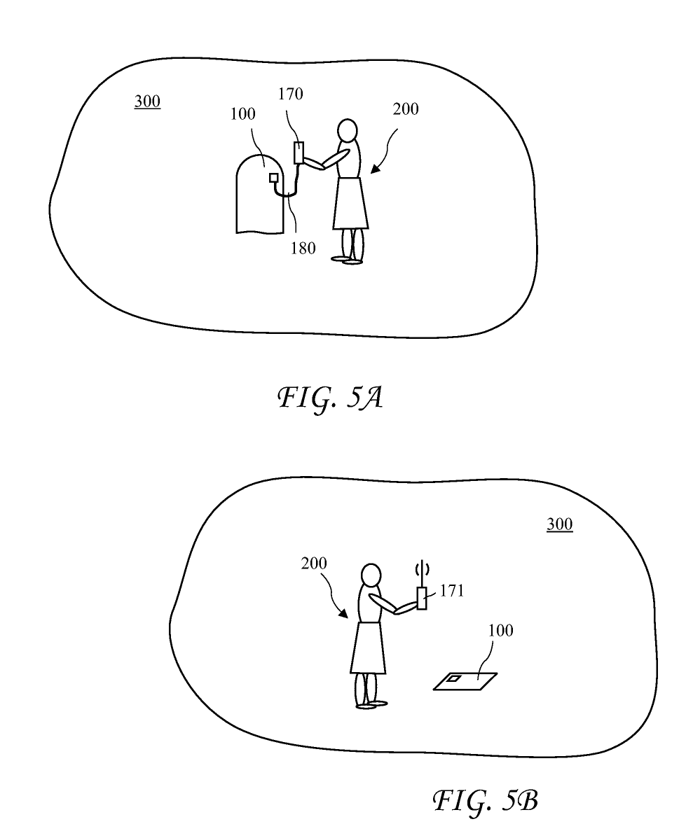

FIG. 5A is a representative perspective view of a preferred embodiment of a method of using an improved apparatus for the data enhanced tombstone 100 such as shown in FIG. 1A and is located within a cemetery 300 or any place of rest for the deceased. When a user 200 is in the vicinity of the data enhanced tombstone 100 of the present invention, a cable interface 180 is used to communicate between user device 170 and the data enhanced tombstone 100.

FIG. 5B is a representative perspective view of a preferred embodiment of a method of using an improved apparatus for a data enhanced grave marker 100 such as shown in FIG. 1B and is located within a cemetery 300 or any place of rest for the deceased. When a user 200 is in the vicinity of the data enhanced grave marker 100 of the present invention, a user device 171 can be connected via a wireless interface to communicate with the data enhanced grave marker 100. Wireless technologies comprise but not limited to RF, Bluetooth and the like.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the invention herein disclosed has been described by means of specific embodiments and applications thereof, numerous modifications and variations could be made thereto by those skilled in the art without departing from the scope of the invention set forth in the claims.

I claim:

1. A tombstone for communicating audio and visual data related to the deceased from the tombstone to a user hand-held device, the tombstone comprising:
an indicia bearing and data storage portion;
a memory storage unit with a cover shield with opening door which covers the memory storage device, for protection thereof the cover shield comprising an access door on the front of the tombstone for access to an interior chamber, the access door having one or more memory chips for large data storage;
a weather-proof interior chamber having a removable interior cylinder with a locking mechanism, the interior chamber further defined by a removable feature with a key for convenient mounting and movement and maintenance of the electronic storage;
a transmitter for communicating electronic data to a user hand-held device, the transmitter comprising a power source to transmit; and
data related to the deceased located within the interior chamber storage device, the data comprising audio and visual images of the deceased, the data stored within storage media; means for accessing the audio and visual images of the deceased from the data related to the deceased utilizing a user hand-held device.

2. The tombstone of claim 1, wherein the user hand-held device is selected from the group consisting of a cell phone, DVD player, laptop or computer, iPAD, Smart phone, Netbook and any device capable of reading the data storage device.

3. The tombstone of claim 1, wherein the data storage device is one or more selected from the group consisting of a flash drive, memory card, SSD, Jump Stick, or electronic data storage devices.

4. The tombstone of claim 1, wherein the storage media is one or more selected from the group consisting of video, text, still photos, and a unique ID number.

5. The tombstone of claim 1, wherein the data will be installed is selected from the group consisting of a laptop, client computer, and network computer containing the information of the deceased.

6. The tombstone of claim 1, further comprising a power source is selected from a group consisting of a solar power cell, battery, or magnetic power source.

7. The tombstone of claim 1, wherein the tombstone is secure from vandalism.

8. The tombstone of claim 2, further including at least method for connectivity is selected from the group consisting of a cable connection or wireless connection to the tombstone.

9. The tombstone of claim 8, further includes the wireless connection selected from the group of Wi-Fi, Bluetooth, Home RF, or IrDA.
